(19) United States
(12) Patent Application Publication
(10) Pub. No.: US 2014/0111852 A1
(43) Pub. Date: Apr. 24, 2014

(54) TELESCOPE WITH IMPROVED FORCE TRANSMISSION PATH

(71) Applicant: Carl Zeiss Sports Optics GmbH, WETZLAR (DE)

(72) Inventor: Armin SCHLIERBACH, LEUN (DE)

(21) Appl. No.: 14/144,736

(22) Filed: Dec. 31, 2013

Related U.S. Application Data
(63) Continuation of application No. PCT/EP2012/063053, filed on Jul. 4, 2012.

(30) Foreign Application Priority Data
Jul. 11, 2011 (DE) 10 2011 107 062.5

(51) Int. Cl. G02B 23/00

(52) U.S. Cl. CPC G02B 23/00
USPC 359/425

(57) ABSTRACT

A telescope having an axially movable optical assembly, in particular, a focusing device and an adjustment device for actuating the optical assembly. A force transmission path from the adjustment device to the optical assembly is formed at least partially by a multitude of force transmission elements arranged abutting on one another in a force transmission channel.

### CROSS-REFERENCE TO RELATED APPLICATIONS

This is a Continuation application of International patent application PCT/EP2012/063053, filed Jul. 4, 2012, which claims the priority of German patent application DE 10 2011 107 062.5, filed Jul. 11, 2011. The entire contents of these prior applications are incorporated herein by reference.

### BACKGROUND OF THE INVENTION

The present invention relates to a telescope having an axially movable optical assembly, in particular an axially movable focusing device, and an adjustment device for actuating the optical assembly. In particular, the telescope can be a binocular telescope having two tubes, which are connected to one another by means of a bridge, the optical assembly of each tube being adjustable by means of an adjustment device.

In telescopes, it is generally usual for them to have a focusing device for adjusting the focus of the telescope. To this end, a lens element of the telescope is usually arranged in the telescope in such a way that it can be displaced in the axial, or longitudinal, direction thereof, adjustment of the focus of the lens arrangement being possible as a result. In the case of telescopes which have only one tube, this axial adjustability may, for example, be provided in that two parts of the tube can be pushed together telescopically into one another. Conventionally, this is used not only to adjust the focusing, but also for the possibility of compact transport of such a telescope. In telescopes of more modern design, and particularly also in binocular telescopes, that is to say a telescope having two tubes, displaceability of parts of the tubes into one another is no longer provided.

Instead, such telescopes have an adjustment device by means of which a user of the telescope can adjust the focusing device conveniently. In particular, the adjustment device is generally arranged in such a way that the user can operate it while he is holding the telescope in front of his eyes. In the case of binocular telescopes, it is in this way possible to ensure that the focusing device is displaced uniformly in both tubes. Nevertheless, binocular telescopes in which the focusing of the tubes can be adjusted separately are also known.

In this case, the adjustment device is usually arranged remotely from the focusing device, so that a force applied to the adjustment device must be forwarded to the focusing device in order to adjust it. This is done by means of suitable mechanical means, which furthermore generally provide suitable gearing in order to permit the finest possible manual adjustment of the focusing device.

For instance, document EP 0 961 147 B1 mentioned in the introduction shows a binocular telescope in which a rotary knob is connected by a gear to focusing means, the gear here having a two-armed lever which engages with one of its ends on the two focusing means and can be pivoted about an axis extending perpendicularly to the longitudinal direction of the telescope, the other end of each lever engaging on an annular stop which can be displaced axially by turning the rotary knob.

Furthermore, document DE 38 30 620 C2 shows a binocular telescope with internal focusing by means of a middle drive lying between the two tubes, the middle drive having a plurality of adjustment rings which can be latched to one another so that adjustment of the focusing members in the two tubes can take place both together and independently of one another.

Lastly, document EP 0 416 346 B1 shows a binocular telescope with a double articulated bridge and a central middle drive, in which a connection between the middle drive and focusing lenses is provided by means of a plurality of threaded spindles, drive shafts and guide rods.

However, all these solution proposals have the disadvantage that they comprise relatively many mechanical parts and can therefore be prone to maintenance and malfunctions. Furthermore, they occupy a relatively large space which, however, is limited in the case of a binocular telescope since the mechanical elements have to be guided through the bridge connecting the tubes. In addition, when using push rods and levers, an articulation is to be provided for each direction change of the flow of force, which occupies further space and may be susceptible to wear.

It is therefore an object of the present invention to provide a telescope in which the force transmission from an adjustment device to a focusing device is provided as far as possible compactly, robustly and with high configuration freedom.

### SUMMARY OF THE INVENTION

According to an aspect of the invention, it is therefore provided a telescope having an axially movable optical assembly and an adjustment device for actuating the optical assembly, wherein a force transmission path from the adjustment device to the optical assembly is formed at least partially by a multitude of force transmission elements arranged abutting on one another in a force transmission channel, wherein the force transmission channel has a closed course so that a start and an end of the force transmission path coincide.

According to a further aspect, there is provided a telescope having an axially movable optical assembly and an adjustment device for actuating the optical assembly, wherein a force transmission path from the adjustment device to the optical assembly is formed at least partially by a multitude of force transmission elements arranged abutting on one another in a force transmission channel, wherein the force transmission channel has a closed course so that a start and an end of the force transmission path coincide on the same force transmission element.

According to a further aspect, there is provided a telescope having an axially movable optical assembly and an adjustment device for actuating the optical assembly, wherein a force transmission path from the adjustment device to the optical assembly is formed at least partially by a multitude of force transmission elements arranged abutting on one another in a force transmission channel.

It is therefore possible to arrange the force transmission channel with any desired course inside the telescope, in order to form parts of the force transmission path. Balls which forward a force applied to the balls at one end of the force transmission channel along its course to one end of the force transmission channel are arranged abutting on one another in the force transmission channel. The space occupied is determined merely by the diameter of the force transmission channel. In particular, no additional elements are necessary in the case of direction changes since the balls in the force transmission channel transmit forces of any angularity to one another. Thus, not only are the configuration possibilities of the telescope increased since a force transmission path with a three-dimensional course can be provided without additional mechanical outlay, but also the possible error susceptibility of the force transmission path is reduced. By virtue of the smaller number of elements to be installed, the proposed solution also offers a cost advantage.

According to one refinement of the invention, the telescope is a binocular telescope having two tubes, which are connected to one another by means of a bridge and each of which has an optical assembly, the respective force transmission path from the adjustment device to one of the optical assemblies being formed at least partially by a multitude of force transmission elements arranged abutting on one another in a respective force transmission channel.

By virtue of this arrangement, owing to the saving on space, it is in particular possible to reduce significantly the size of the bridge, which may be formed as a bent or articulated bridge.

In another refinement of the invention, the force transmission elements in the force transmission channel may be provided at least partially by balls, and in particular the force transmission elements may be provided only by balls.

In this way, it is possible to configure the arrangement of the force transmission channel in the telescope in almost any desired way, without having to take the course into account. In particular, such a configuration may be advantageous when the force transmission path has many changes of direction.

In another refinement of the invention, the force transmission elements in the force transmission channel may be provided both by balls and by rod elements.

In this way, it is possible to use even fewer components in order to provide the force transmission channel. Sections in which the force transmission channel does not have a curved course may also be provided by rod elements for force transmission. Balls are correspondingly to be used only in regions in which the force transmission channel has a curved course.

In another refinement of the invention, the entire force transmission path may be formed by the force transmission channel.

In principle, the entire force transmission path need not be formed by the force transmission channel. Substantial advantages can be achieved directly when this is only partially the case. As an optional extension, a gear or a two-sided lever may also be provided at the start or end of the force transmission channel, in order to provide a desired conversion of forces or distances. If no such conversion is desired, or 1:1 conversion is desired, the force transmission channel may form the entire force transmission path and thus fully offer its advantages.

In another refinement of the invention, the force transmission channel may be formed by straight sections and at least one curved section, the ratio of a radius of a curve described by a ball center to a respective radius of the balls being at least 1.2.

In another refinement of the invention, the ratio of the radius of the curve described by the ball center to the respective radius of the balls may be at least 1.5.

In this way, it is possible to ensure a certain minimum radius of the curved section relative to a radius of the balls arranged in the force transmission channel. The effect achieved by this is that reliable force transmission takes place over the course of the force transmission channel and excessive friction between the balls, or the balls and the rod elements, which may lead to jerky movements and therefore inconvenient adjustment of the focusing device, does not take place in the region of the curved sections.

In another refinement of the invention, a cross section of the force transmission channel may be round.

In this way, the force transmission channel occupies minimal space in relation to the ball size.

In one refinement of the invention, furthermore, a cross section of the force transmission channel may be square.

In this way, although the force transmission channel occupies a larger space compared with the round configuration, the balls arranged in the force transmission channel nevertheless abut on its inner wall only at four points, so that lower friction forces act and more sensitive force transmission can be carried out.

Of course, it is furthermore possible for the cross section of the force transmission channel to be formed in other shapes. For example, the cross section of the force transmission channel may also be triangular. Generally, in combination with all other embodiments of the invention, any desired n-sided shape of the cross section of the force transmission channel is possible, where n is any desired integer.

In another refinement of the invention, the force transmission channel may be integrated into a housing of the telescope.

In this way, a particularly compact and economical structure is possible. Mounting of the telescope is also substantially facilitated thereby.

In another refinement of the invention, the optical assembly may be a focusing device.

Focusing devices are conventionally provided in a telescope and adjustable by means of an adjustment device. Furthermore, lens groups having a plurality of lenses are often moved in focusing devices, so that robust force transmission even of relatively high forces, which may be necessary for moving a plurality of lenses, is provided by means of the proposed force transmission channel.

In another refinement of the invention, the force transmission channel may have a closed course, or a closed geometry.

A “closed course” or a “closed geometry” is intended to mean that a start and an end of the force transmission path coincide, or coincide on the same force transmission element. This makes it possible to transmit forces in both axial directions, that is to say it is also possible “to pull”, or push in the opposite direction. A flow of force can thus be transmitted in both directions. Furthermore, a spring element for restoring is not necessary, so that friction acting during the force transmission is reduced. The closed course may be circular or rectangular, in particular with rounded corners, in its geometry in an axial longitudinal section, although it may have any other suitable geometry.

It is to be understood that the features mentioned above and those yet to be explained below may be used not only in the combination respectively indicated, but also in other combinations or individually, without departing from the scope of the present invention.

### BRIEF DESCRIPTION OF THE DRAWINGS

Exemplary embodiments of the invention are represented in the drawings and will be explained in more detail in the description below.

FIG. 1 shows a schematic cross-sectional view of a telescope in a first embodiment,

FIGS. 2a-2f show various embodiments of a force transmission channel,

FIG. 3 shows a perspective representation of a telescope in another embodiment,

FIG. 4 shows a partially cut-away top view of the telescope in FIG. 3,

FIG. 5 shows a schematic cross-sectional view of the course of a force transmission channel, and

FIG. 6 shows a schematic cross-sectional view of a telescope in yet another embodiment.

### DETAILED DESCRIPTION OF THE PREFERRED EMBODIMENT

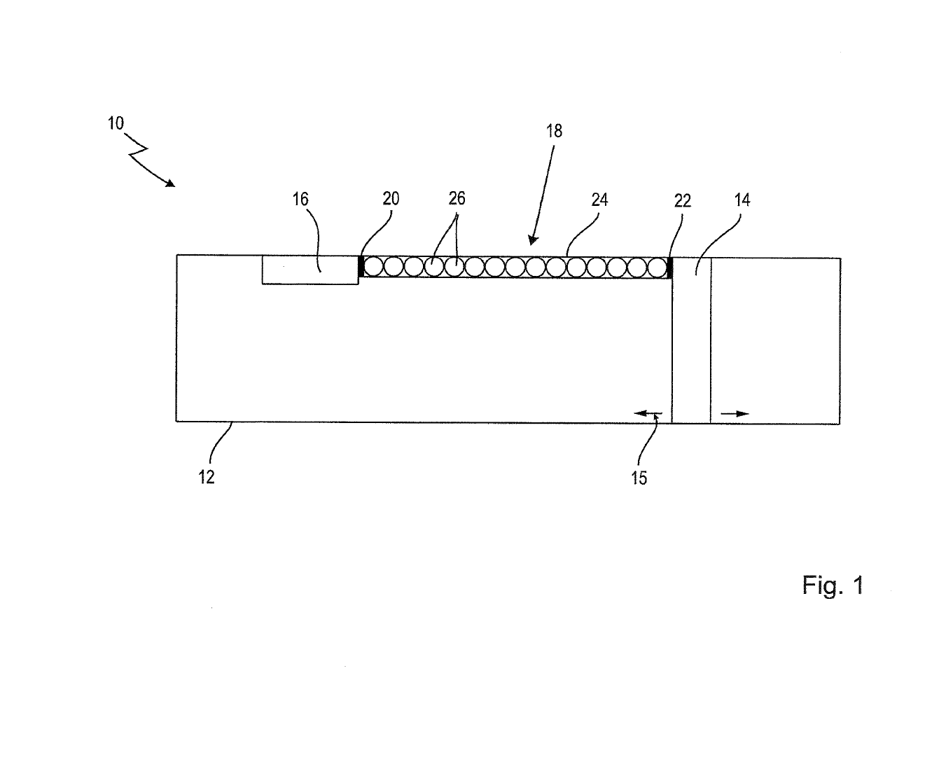

FIG. 1 shows a schematic cross-sectional view of a first embodiment of a telescope 10. The telescope 10 has a housing 12. The housing 12 contains an optical assembly 14 which can be displaced in an axial direction 15, that is to say parallel to an optical axis of the telescope 10, and an adjustment device 16. In particular, the optical assembly 14 may be a focusing device, although it may also be another optical assembly, for example for changing a magnification of the telescope. The adjustment device 16 is used so that the optical assembly 14 can be displaced manually along the axial direction 15 in order to adjust an optical property of the telescope 10, in particular the focusing, as desired.

In order to make this possible, a force transmission path 18 is provided, which extends between a start 20 and an end 22. Along the force transmission path 18, a force introduced at the adjustment device 16 is transmitted to the optical assembly 14, and the latter is thus moved in the axial direction 15.

In the embodiment represented, the force transmission path 18 is formed by a force transmission channel 24. A multitude of force transmission elements are arranged abutting on one another in the force transmission channel 24; in the embodiment represented, the force transmission elements are formed by balls 26. In this way, it is possible for a force applied by the adjustment device 16 to the balls 26 at the start 20 to be communicated by means of the balls 26 abutting on one another through the force transmission channel 24 to the end 22, and to be applied to the optical assembly 14 which can therefore be moved along the axial direction 15.

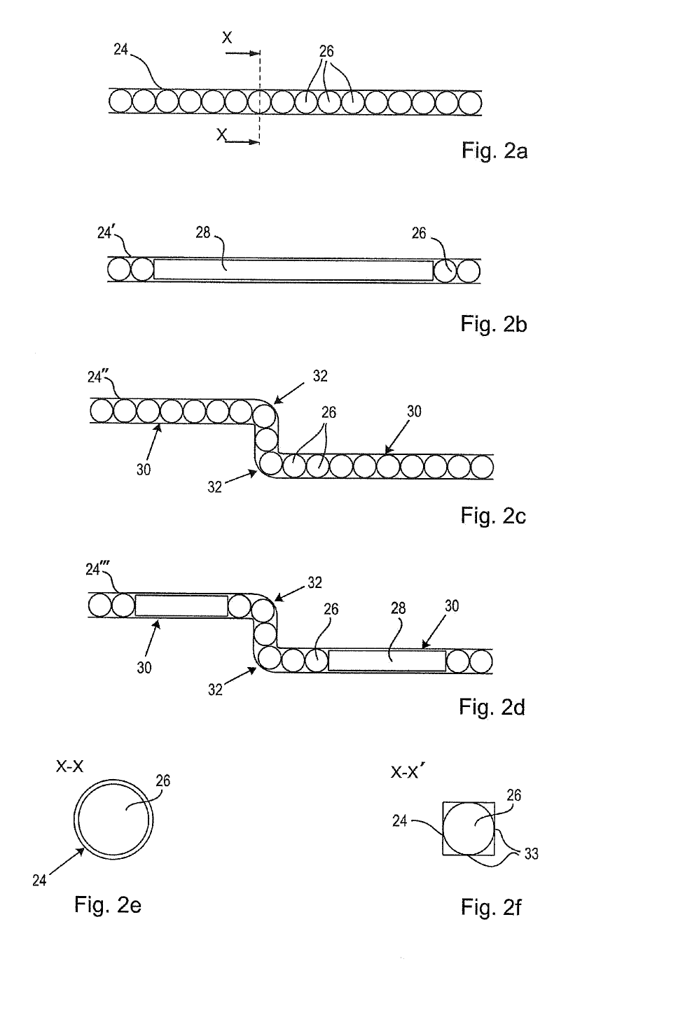

FIGS. 2a to 2f show various embodiments of the force transmission channel 24. In this case, FIGS. 2a to 2d show a force transmission channel 24 in a plurality of embodiments in longitudinal section. FIGS. 2e and 2f show various embodiments of the force transmission channel 24 in cross section along a line X-X in FIG. 2a.

FIG. 2a represents the force transmission channel 24 as used in FIG. 1. This force transmission channel 24 contains only balls 26.

FIG. 2b represents another embodiment 24′ of the force transmission channel. Besides balls 26, a rod element 28 is also arranged in the force transmission channel 24′. By means of the rod element 28, a longer distance can be bridged along a straightly extending course of the force transmission channel 24′, and the number of individual elements can thus be reduced. The arrangement represented is to be understood merely by way of example. For example, rod elements 28 may also respectively be provided at the start 20 and at the end 22, there then being a plurality of balls 26 between them.

FIG. 2c shows another embodiment 24″ of the force transmission channel, which has two straight sections 30 and two curved sections 32. The course of the force transmission channel 24″ is in this case to be understood merely by way of example, and a different combination of straight sections 30 and curved sections 32 is of course also possible. In the embodiment represented, only balls 26 are arranged in the force transmission channel 24″.

FIG. 2d shows yet another exemplary embodiment 24′″ of a force transmission channel, which likewise has straight sections 30 and curved sections 32. However, both balls 26 and rod elements 28 are arranged in the force transmission channel 24′″.

FIG. 2e shows a cross section along a line X-X of FIG. 2a in a first embodiment. In the embodiment represented, the balls 26 naturally have a circular cross section. Furthermore, the force transmission channel 24 also has a circular cross section.

FIG. 2f represents another embodiment X-X′ of the cross section, which is likewise taken along the line X-X in FIG. 2a. In this embodiment, the force transmission channel 24 has a square cross section. One advantage of this embodiment is that the ball 26 abuts on the force transmission channel 24 only at particular points 33, in the embodiment represented a total of four points 33. In this way, the friction between the balls 26 and the force transmission channel 24 can be reduced.

The cross-sectional shape of the rod element 28 may also be round in all the embodiments represented, for instance in the embodiment represented in FIG. 2e. If the force transmission channel 24 has an n-sided, in particular square, cross section, as is represented for example in FIG. 2f, the rod elements 28 may likewise have a round cross section like balls 26. The cross section of the rod elements 28 may, however, also be matched to the n-sided cross section of the force transmission channel 24.

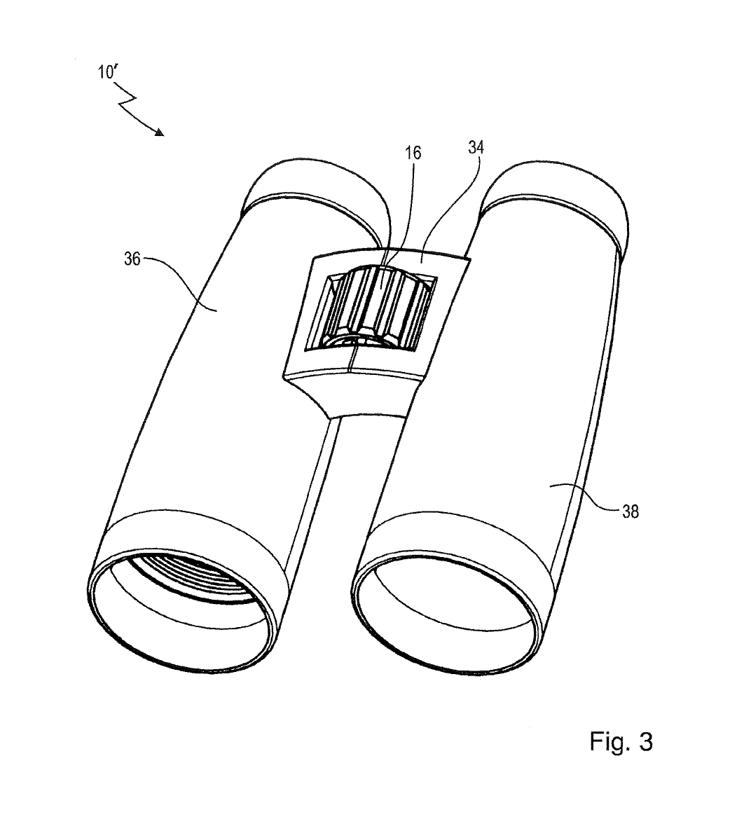

FIG. 3 shows another embodiment of a telescope 10′. The telescope 10′ is a binocular telescope. It has a bridge 34, which connects a first tube 36 and a second tube 38 to one another. The bridge 34 may, for example, be formed as an articulated bridge or as a bent bridge. In the embodiment represented, the adjustment device 16 is arranged in the bridge 34. In this way, a focusing device 14′ can be manually adjusted by a user of the telescope 10′ by means of the adjustment device 16 while he is looking through the telescope 10′.

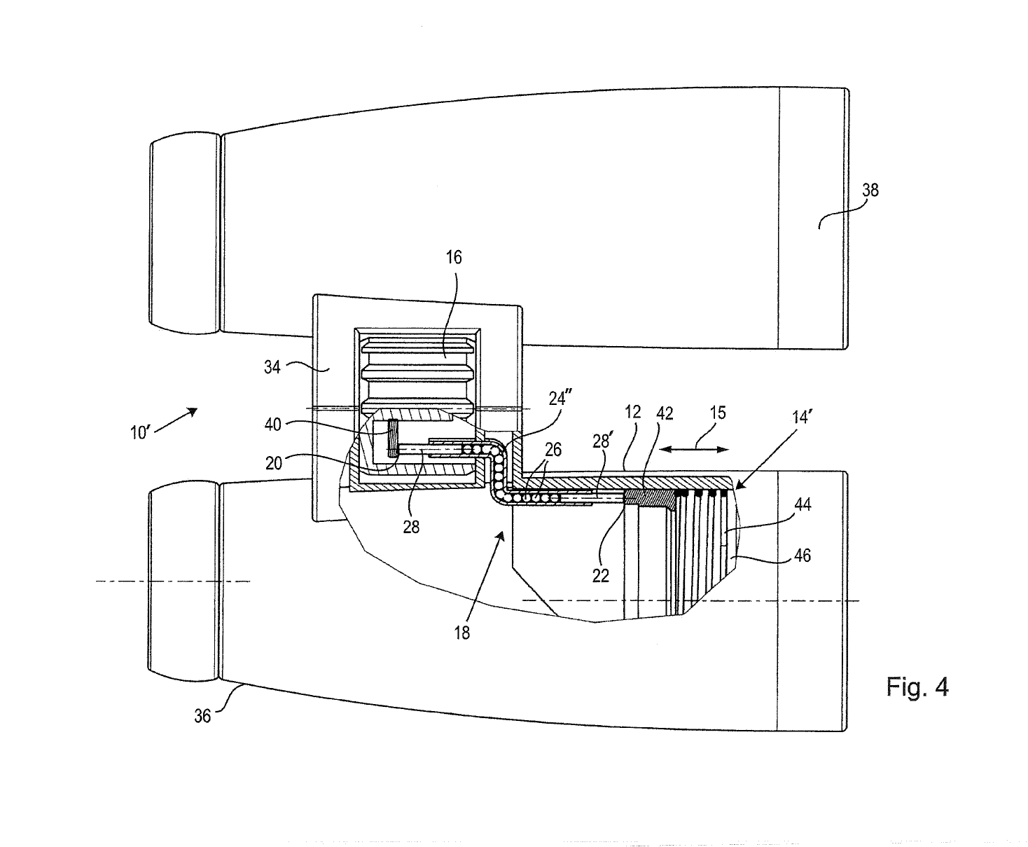

FIG. 4 shows the telescope 10′ represented in FIG. 3 in a partially cut-away top view. In relation to the first embodiment as represented in FIG. 1, elements which are the same are denoted by the same references. Only the differences will be discussed below.

The adjustment device 16 has a contact element 40, which during manual actuation of the adjustment device 16 is pressed against the start 20 of the force transmission path 18 and thus exerts a force on a rod element 28. This force is transmitted forward along the force transmission channel 24 onto the rod element 28′. At the end 22 of the force transmission path 18, the rod element 28′ transmits the pressure force, originally exerted by the contact element 40 on the force transmission path 18, onto a sleeve element 42. The sleeve element 42 in turn forwards this force onto the focusing device 14′. The focusing device 14′ may have a spring element 44 for restoring the focusing device 14′ and one or more lens elements 46, in order in this case to suitably influence the focusing of the first tube 36.

In the embodiment represented, rod elements 28, 28′ are provided at the start 20 and at the end 22 of the force transmission path 18. Such a configuration may be provided in particular when the contact element 40, or the sleeve element 42, is intended to be moved over a large distance, since otherwise balls 26 could possibly fall out of the force transmission channel 24. With rod elements 28, 28′ of suitable length, however, this is prevented.

With the aid of this force transmission channel 24, it is thus possible to transmit the force from the bridge 34, or the adjustment device 16, to the focusing device 14′ without mechanical elements such as levers, threaded spindles, etc. The transmission is carried out merely by means of the force transmission channel 24, which makes it easy to implement changes of direction in the flow of force, in particular by virtue of the balls 26.

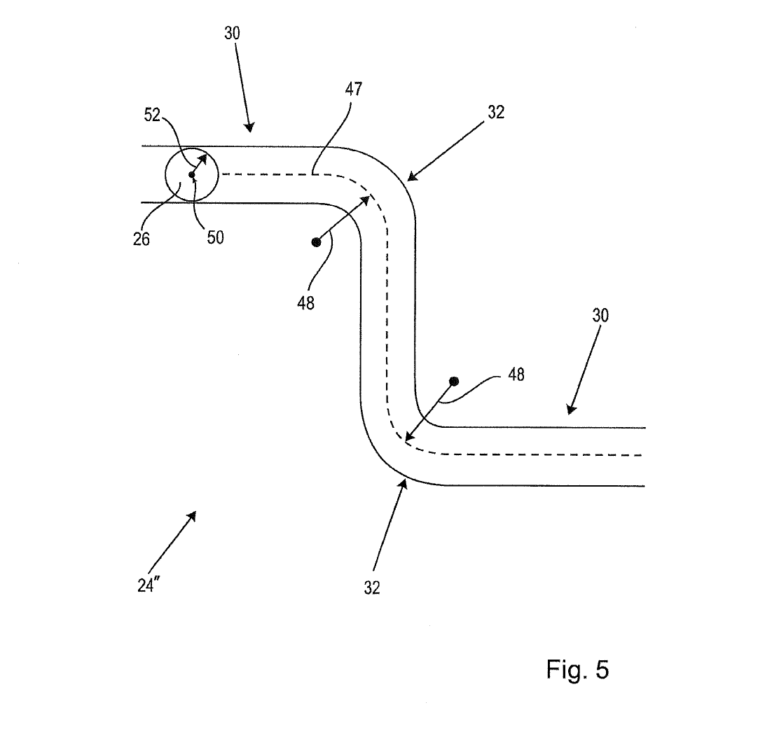

FIG. 5 shows a schematic cross-sectional view of a force transmission channel 24″. The force transmission channel 24″ has a longitudinal axis 47. The longitudinal axis 47 is curved along the curved sections 32. The curvature in this case follows a curve radius 48. During its movement through the force transmission channel 24″, a ball center 50 of the balls 26 precisely follows the path along the longitudinal axis 47. The balls 26 each have a ball radius 52. In order to ensure that the balls 26 can move through the curved sections 32, or in the curved sections 32, with low friction forces and without jamming, the curve radius 48 and the ball radius 52 are to be set in a particular minimum ratio with respect to one another. If the curved section 32 is selected to be very narrow, for example when the balls 26 have to navigate a 90° corner, the curve radius 48 which the ball center 50 describes on the longitudinal axis 47 corresponds precisely to the ball radius 52. In this case, however, jamming may occur. For this reason, the curve radius 48 should be greater than the ball radius 52. In order to ensure suitable movement of the balls 26, the curve radius 48 should therefore correspond to 1.2 times the ball radius 52, and in particular correspond to 1.5 times the ball radius 52. This ensures that movement of the balls 26 in the force transmission channel 24 is hindered only by low friction forces. Although the ratio of the radii 48, 52 has been represented by way of example with the aid of the embodiment 24″ of the force transmission channel, the corresponding teaching also applies for all other embodiments.

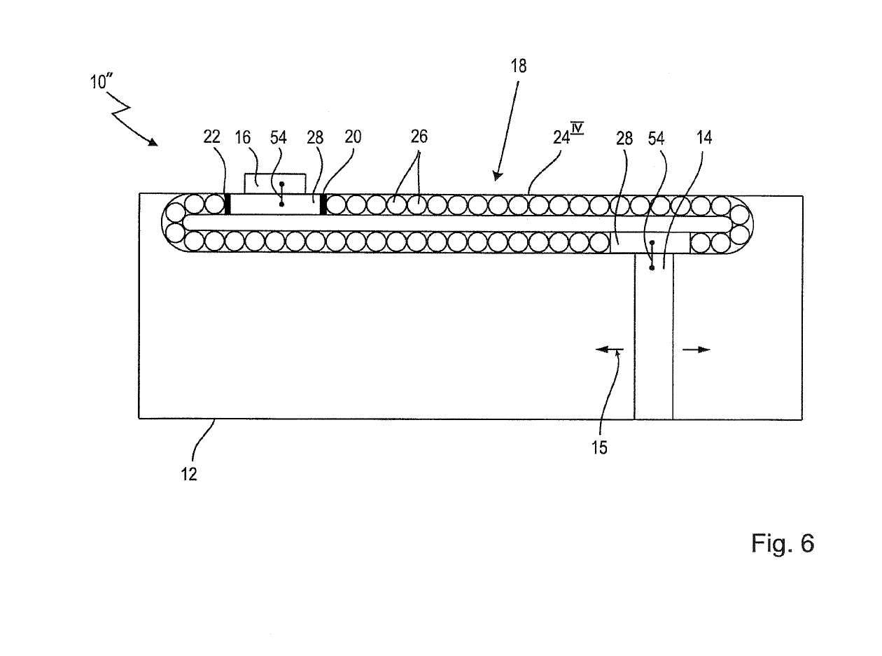

FIG. 6 schematically represents yet another embodiment of a telescope 10″. Elements which are the same are in this case denoted by the same references and act in a similar way. Only the differences from the previous embodiments will be discussed below.

The telescope 10″ has a force transmission channel 24^{IV}. The force transmission channel 24^{IV} has a closed course. This means that the start 20 and the end 22 of the force transmission path 18 coincide, or coincide on a particular force transmission element. In the embodiment represented in FIG. 6, this is represented by way of example for the rod element 28, which is connected by means of a schematically represented coupling mechanism 54 to the adjustment element 16. The adjustment device 16 may, however, also engage directly in the force transmission channel 24^{IV}. A further rod element 28 is likewise connected by means of a coupling mechanism to the optical assembly 14. The optical assembly 14 may, however, also be connected to a force transmission element which is not formed as a rod element 28. A configuration of suitable coupling mechanisms 54 is known in principle to the person skilled in the art and will not be discussed in further detail here.

The schematic view represented in FIG. 6 corresponds approximately to a longitudinal section through the telescope 10″. In this longitudinal section, the force transmission channel 24^{IV} has an approximately rectangular geometry with rounded corners, although other geometries may also be envisioned, for example a square or circular geometry. The closed course of the force transmission channel 24^{IV} offers the advantage that pressure forces can be introduced in both directions into the force transmission path 18 by means of the adjustment device 16 via the coupling mechanism 54, and the optical assembly 14 can thus be moved in both axial directions without. A particular advantage in this case is that no spring element 44 is required, so that friction forces acting during actuation of the adjustment element 16 are reduced.

We claim:

1. A telescope having an axially movable optical assembly and an adjustment device for actuating the optical assembly, wherein a force transmission path from the adjustment device to the optical assembly is formed at least partially by a multitude of force transmission elements arranged abutting on one another in a force transmission channel, wherein the force transmission channel has a closed course so that a start and an end of the force transmission path coincide.

2. A telescope having an axially movable optical assembly and an adjustment device for actuating the optical assembly, wherein a force transmission path from the adjustment device to the optical assembly is formed at least partially by a multitude of force transmission elements arranged abutting on one another in a force transmission channel, wherein the force transmission channel has a closed course so that a start and an end of the force transmission path coincide on the same force transmission element.

3. A telescope having an axially movable optical assembly and an adjustment device for actuating the optical assembly, wherein a force transmission path from the adjustment device to the optical assembly is formed at least partially by a multitude of force transmission elements arranged abutting on one another in a force transmission channel.

4. The telescope as claimed in claim 3, wherein the telescope is a binocular telescope having two tubes, which are connected to one another by means of a bridge and each of which has an optical assembly, the adjustment device being arranged in the bridge and the respective force transmission path from the adjustment device to one of the optical assemblies being formed at least partially by a multitude of force transmission elements arranged abutting on one another in a respective force transmission channel.

5. The telescope as claimed in claim 3, wherein the force transmission elements in the force transmission channel are provided only by balls.

6. The telescope as claimed in claim 3, wherein the force transmission elements in the force transmission channel are provided both by balls and by rod elements.

7. The telescope as claimed in claim 3, wherein the entire force transmission path is formed by the force transmission channel.

8. The telescope as claimed in claim 3, wherein the force transmission channel is formed by straight sections and at least one curved section, a ratio of a radius of a curve described by a ball center to a respective radius of the balls being at least 1.2.

9. The telescope as claimed in claim 8, wherein the ratio of the radius of the curve described by the ball center to the respective radius of the balls is at least 1.5.

10. The telescope as claimed in claim 3, wherein a cross section of the force transmission channel is round.

11. The telescope as claimed in claim 3, wherein a cross section of the force transmission channel is square.

12. The telescope as claimed in claim 3, wherein the force transmission channel is integrated into a housing of the telescope.

13. The telescope as claimed in claim 3, wherein the optical assembly is a focusing device.

14. The telescope as claimed in claim 3, wherein the force transmission channel has a closed course.
